(19) United States
(12) Patent Application Publication
(10) Pub. No.: US 2019/0220807 A1
(43) Pub. Date: Jul. 18, 2019

(54) SYSTEM, INFORMATION PROCESSING DEVICE, INFORMATION PROCESSING METHOD, PROGRAM, AND RECORDING MEDIUM

(71) Applicant: NS Solutions Corporation, Tokyo (JP)

(72) Inventor: Eiichi YOSHIDA, Tokyo (JP)

(21) Appl. No.: 16/334,308

(22) PCT Filed: Dec. 25, 2017
(86) PCT No.: PCT/JP2017/046303

§ 371 Date: Mar. 18, 2019

(30) Foreign Application Priority Data
Feb. 10, 2017 (JP) 2017-022900

(51) Int. Cl. G06Q 10/08; G06F 16/587; G06T 7/60; G06T 7/73

(52) U.S. Cl. CPC G06Q 10/087; G06T 7/73; G06T 7/60; G06F 16/587

(57) ABSTRACT

The present invention is configured to obtain position information of an article photographed with an imaging device in a first warehouse work as position information used in a second warehouse work performed after the first warehouse work and register the obtained position information and identification information of the article in a storage unit. The position information is associated with the identification information of the article.

### TECHNICAL FIELD

The present invention relates to a system, an information processing device, an information processing method, a program, and a recording medium.

### BACKGROUND ART

There is a system for picking support using an information processing device such as smart glasses. (Patent Literature 1)

### CITATION LIST

### Patent Literature

Patent Literature 1: Japanese Laid-open Patent Publication No. 2014-43353

### SUMMARY OF INVENTION

### Technical Problem

Recently, a system using AR glasses such as smart glasses having a function that displays an image for picking support with being superimposed on an actual scene has been proposed. Such a system is configured to present position information of a picking target to a worker. However, in a distribution warehouse or the like where warehousing and delivery are repeatedly performed every day, a place on which an article is placed is displaced from hour to hour. That is, there is a case where the position information of the article has been incorrectly registered. In such a state, the system cannot present exact position information to the worker.

Only information regarding which shelf stores the article is registered as the position information in many cases, and the system cannot instruct the worker which of an upper stage, a middle stage, and a lower stage, and a left row, a center row, and a right row in this shelf stores the article. Thus, the worker takes a time to search the article and cannot perform efficient picking.

### Solution to Problem

Therefore, a system of the present invention includes an obtainer and a register. The obtainer is configured to obtain position information of an article photographed with an imaging device in a first warehouse work, as position information used in a second warehouse work performed after the first warehouse work. The register is configured to register the position information obtained by the obtainer and identification information of the article in a storage unit. The position information is associated with the identification information of the article.

### Advantageous Effects of Invention

With the present invention, in a work in a warehouse, the position information of the article can be obtained and registered for use in a later work.

### BRIEF DESCRIPTION OF DRAWINGS

FIG. 1 is a diagram illustrating an exemplary system configuration of an information processing system.

FIG. 2 is a diagram illustrating an exemplary hardware configuration and the like of smart glasses.

FIG. 3 is a diagram illustrating an exemplary hardware configuration of a server device.

FIG. 4 is a diagram describing an outline of an exemplary process of the information processing system.

FIG. 5 is a diagram illustrating an exemplary situation in picking.

FIG. 6 is a sequence diagram illustrating an exemplary process of the information processing system.

FIG. 7 is a diagram illustrating an exemplary picking instruction screen.

FIG. 8 is a diagram illustrating an exemplary photographed location marker.

FIG. 9 is a diagram illustrating an exemplary situation of a worker in photographing.

FIG. 10 is a diagram illustrating an exemplary correspondence table.

FIG. 11 is a diagram illustrating an exemplary image of the photographed location marker.

FIG. 12 is a diagram describing an exemplary estimating method for a height.

FIG. 13 is a diagram illustrating an exemplary position information presentation screen.

FIG. 14 is a flowchart illustrating an exemplary process of the smart glasses.

FIG. 15 is a diagram describing an exemplary movement of an article.

FIG. 16 is a diagram describing an exemplary movement of an article.

FIG. 17 is a diagram illustrating an exemplary position information presentation screen.

FIG. 18 is a diagram illustrating an exemplary position information presentation screen.

FIG. 19 is a diagram illustrating an exemplary position information presentation screen.

FIG. 20 is a diagram illustrating an exemplary situation in picking.

FIG. 21 is a diagram illustrating an exemplary situation in picking.

### DESCRIPTION OF EMBODIMENTS

### Embodiment 1

The following describes an embodiment of the present invention based on the drawings.

(System Configuration)

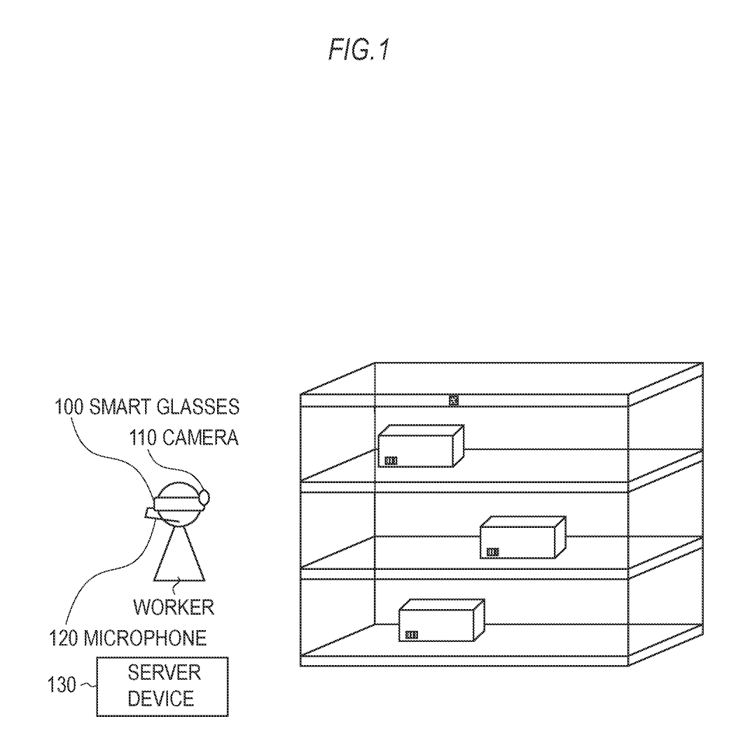

FIG. 1 is a diagram illustrating an exemplary system configuration of an information processing system.

The information processing system, which is a system that supports a warehouse work of a worker as a user, includes a single pair of or plural pairs of smart glasses 100 and a server device 130. The warehouse work is a work in a warehouse such as a picking work of an article, a warehousing work of the article, an inventory work, and an organizing work caused by rearrangement of the article. The warehouse is a facility used for storage of the article. The storage of the article includes, for example, a temporal storage of the article such as a storage of a commodity from when an order is accepted and until when the commodity is sent, a temporal storage of a processed product of a product produced in a plant or the like, and a long-term storage of the article such as a stock or a reserve of a resource. The smart glasses 100 are coupled to the server device 130 via a network communicably by air.

The smart glasses 100, which are a glasses-type information processing device carried by the worker who actually picks the article, are coupled to a camera 110 and a microphone 120. In this embodiment, the smart glasses 100 are worn by the worker who picks the article.

The server device 130 is an information processing device that gives an instruction for picking to the smart glasses 100. The server device 130 is configured from, for example, a personal computer (PC), a tablet device, and a server device.

(Hardware Configuration)

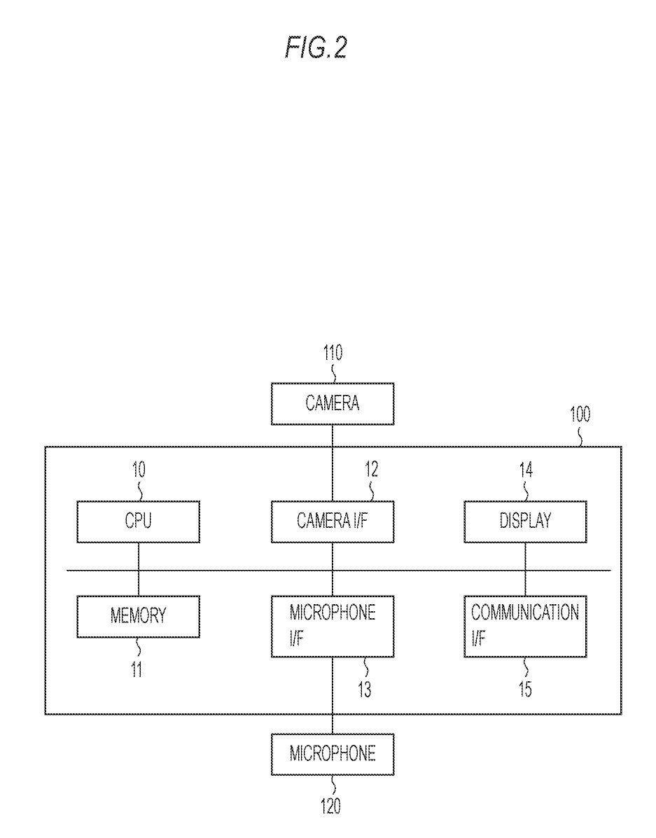

FIG. 2 is a diagram illustrating an exemplary hardware configuration and the like of the smart glasses 100. The smart glasses 100 include a processor such as a CPU 10, a memory 11, a camera I/F 12, a microphone I/F 13, a display 14, and a communication I/F 15. The respective configurations are coupled via a bus or the like. However, a part of or all of the respective configurations may be configured from different devices communicatively coupled by wire or by air. The smart glasses 100 are integrally coupled to the camera 110 and the microphone 120. Therefore, an elevation/depression angle and an azimuth angle formed by the smart glasses 100 will match an elevation/depression angle and an azimuth angle formed by the camera 110.

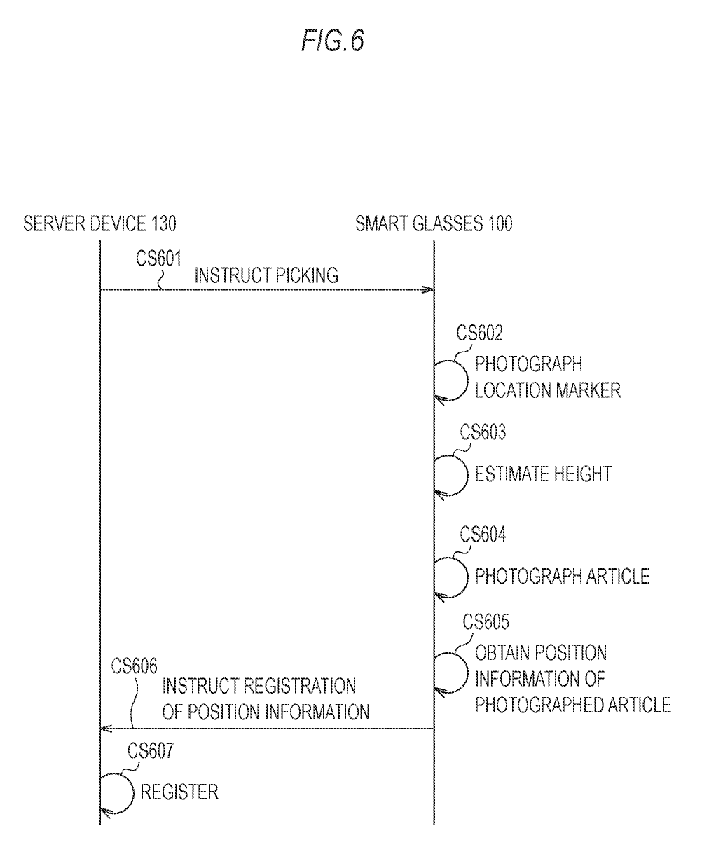

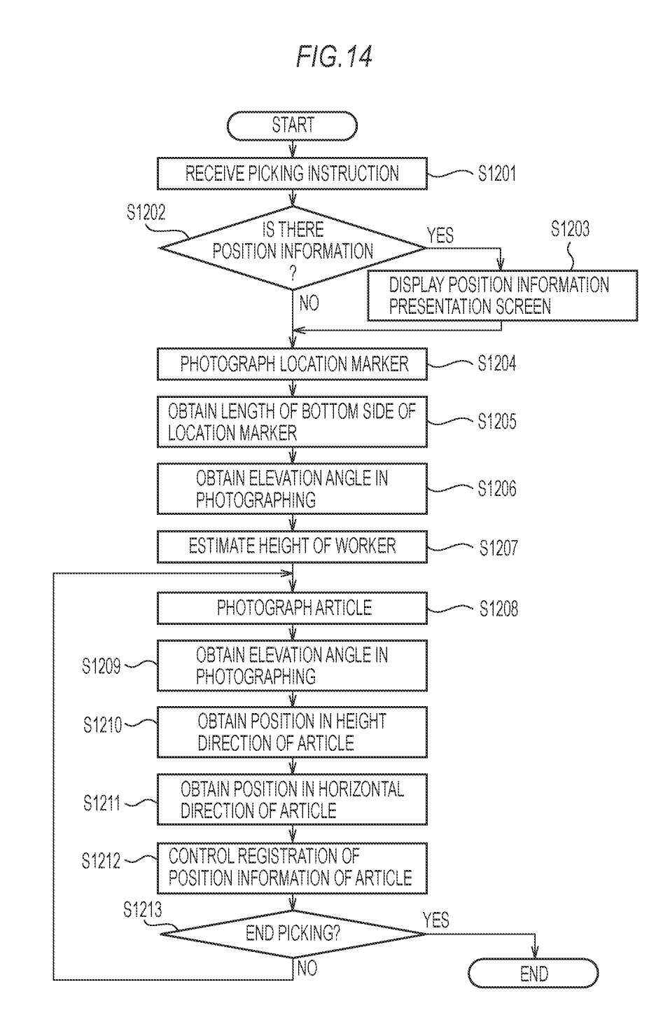

The CPU 10 controls the whole smart glasses 100. The CPU 10 executes a process based on a program stored in the memory 11 to achieve a function of the smart glasses 100, a process of the smart glasses 100 in a process in a sequence diagram in FIG. 6, which is described below, a process in a flowchart in FIG. 14, and the like. The memory 11 stores the program, data used when the CPU 10 executes the process based on the program, and the like. The memory 11 is an exemplary recording medium. The program may be, for example, stored in a non-temporarily recording medium to be read into the memory 11 via an input/output I/F. The camera I/F 12 is an interface to couple the smart glasses 100 to the camera 110. The microphone I/F 13 is an interface to couple the smart glasses 100 to the microphone 120. The display 14 is a display unit of the smart glasses 100. The display 14 is configured from a display and the like for realizing Augmented Reality (AR). The communication I/F 15 is an interface to communicate with another device, for example, the server device 130 by wire or by air.

The camera 110 photographs an object such as a two-dimensional code, a barcode, and color bits attached to the article based on a request from the smart glasses 100. The camera 110 is an exemplary imaging device carried by the worker. The microphone 120 inputs audio of the worker as voice data to the smart glasses 100 and outputs audio corresponding to the request from the smart glasses 100.

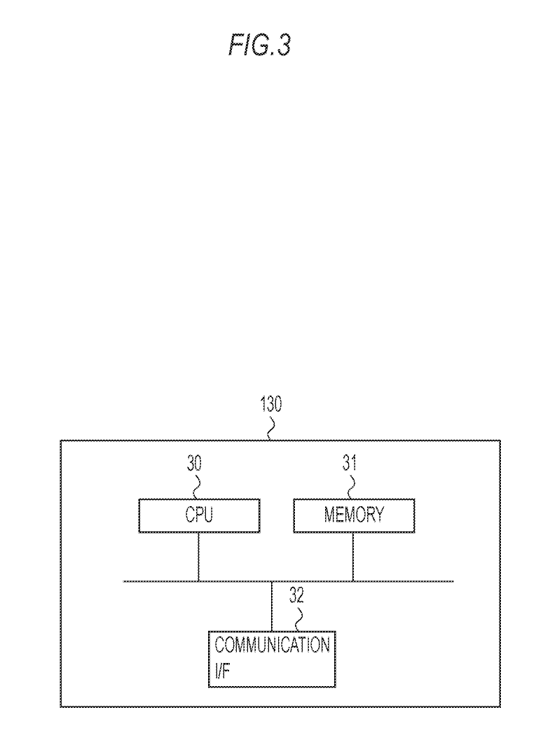

FIG. 3 is a diagram illustrating an exemplary hardware configuration of the server device 130. The server device 130 includes a processor such as a CPU 30, a memory 31, and a communication I/F 32. The respective configurations are coupled via the bus or the like.

The CPU 30 controls the whole server device 130. The CPU 30 executes a process based on a program stored in the memory 31 to achieve a function of the server device 130, a process of the server device 130 in the process in the sequence diagram in FIG. 6, which is described below, and the like. The memory 31 is a storage unit of the server device 130. The memory 31 stores the program, data used when the CPU 30 executes the process based on the program, and the like. The memory 31 is an exemplary recording medium. The program may be, for example, stored in a non-temporarily recording medium to be read into the memory 31 via an input/output I/F. The communication I/F 32 is an interface to communicate with another device, for example, the smart glasses 100 by wire or by air.

(Outline of Process in the Embodiment)

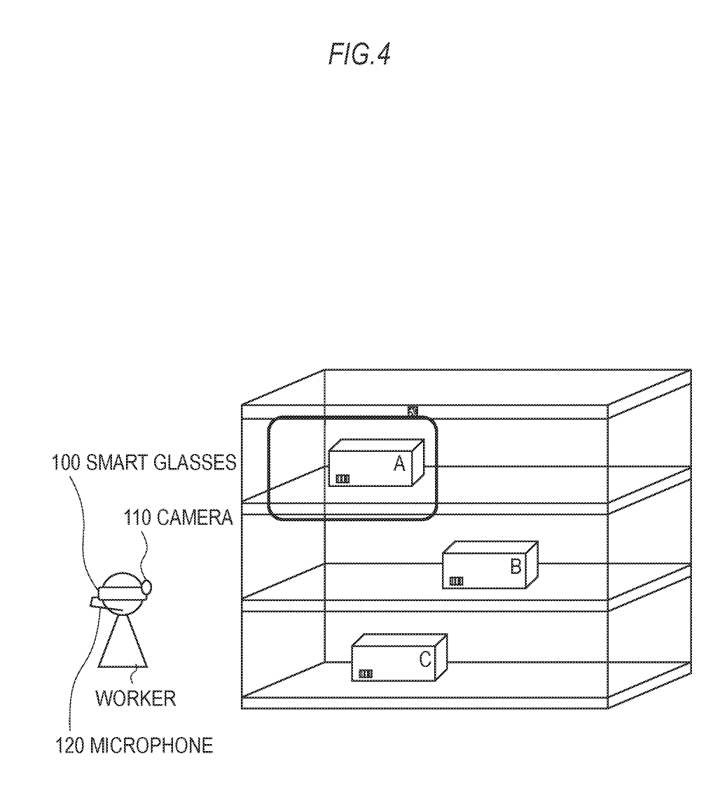

FIG. 4 is a diagram describing an outline of an exemplary process of the information processing system. The outline of the process of the information processing system in this embodiment will be described using FIG. 4.

A situation in FIG. 4 is a situation where the worker, who is wearing the smart glasses 100 and has been instructed to pick an article C, is searching the article C. The worker may unintentionally bring another article other than the article C into sight as trying to find the article C. At this time, the camera 110 will photograph the other article that the worker has brought into sight. The smart glasses 100 are configured to know which article has been photographed by recognizing a marker stuck on the other article photographed with the camera 110. A frame in FIG. 4 is a frame indicating a range photographed with the camera 110, thus knowing that an article A has been photographed.

That is, when the worker who is wearing the smart glasses 100 performs the picking, the information processing system may photograph various articles other than the article as a picking target. The information processing system obtains position information of the article that the worker has visually perceived during the picking to register the obtained position information of this article in the memory 31 and the like. Then, the information processing system presents the position information of this article to a subsequent worker, who comes to pick the article whose position information has been registered, after the prior worker, thus supporting the subsequent worker.

Thus, the information processing system obtains and registers the position information of the article photographed with the camera 110 carried by the worker to ensure the support to the subsequent worker who comes to pick this article.

(Situation in Picking)

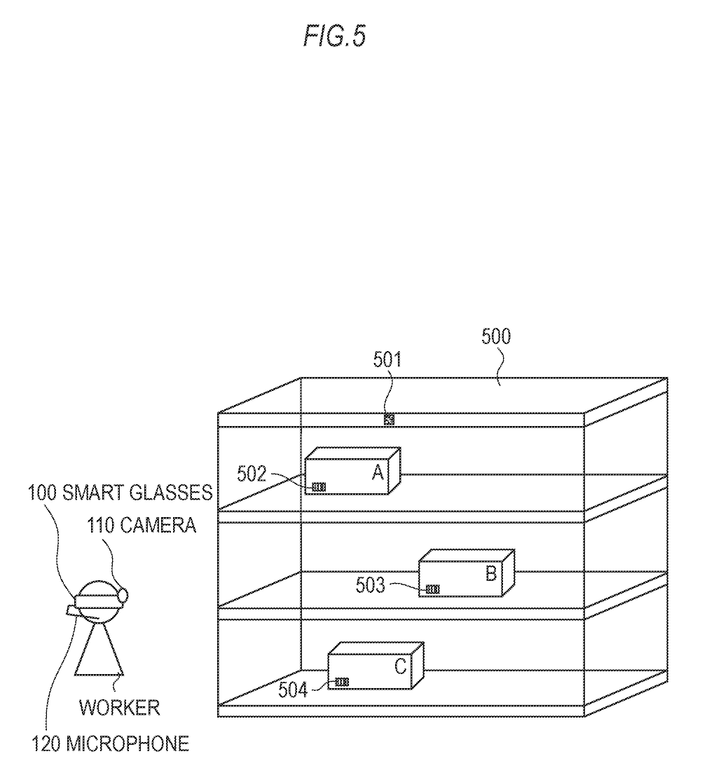

FIG. 5 is a diagram illustrating an exemplary situation in the picking according to the embodiment.

The situation in FIG. 5 is a situation where the worker who is wearing the smart glasses 100 is going to pick the article C stored in a shelf 500. A location marker 501 has been stuck on a set position higher than a height of the worker in the shelf 500. The article A, an article B, and the article C have been placed in the shelf 500. Markers 502, 503, and 504 have been stuck on the article A, the article B, and the article C respectively. The shelf 500 is an exemplary placed portion where the article is placed.

The location marker 501 is a marker such as the two-dimensional code, the barcode, and a color code indicating the position information of the shelf. In this embodiment, the location marker 501 is assumed to be the two-dimensional code and a rectangular marker. The markers 502, 503, and 504 are respective markers indicating information on the articles on which the markers 502, 503, and 504 have been stuck.

The following describes a process of the information processing system in this embodiment in the situation illustrated in FIG. 5.

(Obtaining/Registering Process of Position information of Article)

FIG. 6 is the sequence diagram illustrating an exemplary process of the information processing system. An obtaining/registering process of the position information of the article will be described using FIG. 6.

In CS601, the CPU 30 transmits a picking instruction of the article C as the picking target article to the smart glasses 100. The CPU 30 puts the position information of the shelf 500 where the article C as the picking target has been stored, an article code of the article C, information on a name, information on the number of the articles C to be picked, and the like in the picking instruction to be transmitted. The article code is exemplary identification information of the article.

The CPU 10, after receiving the picking instruction, displays a picking instruction screen, which instructs the picking, with being superimposed on an actual scene, on the display 14, for example, based on the information included in the received picking instruction.

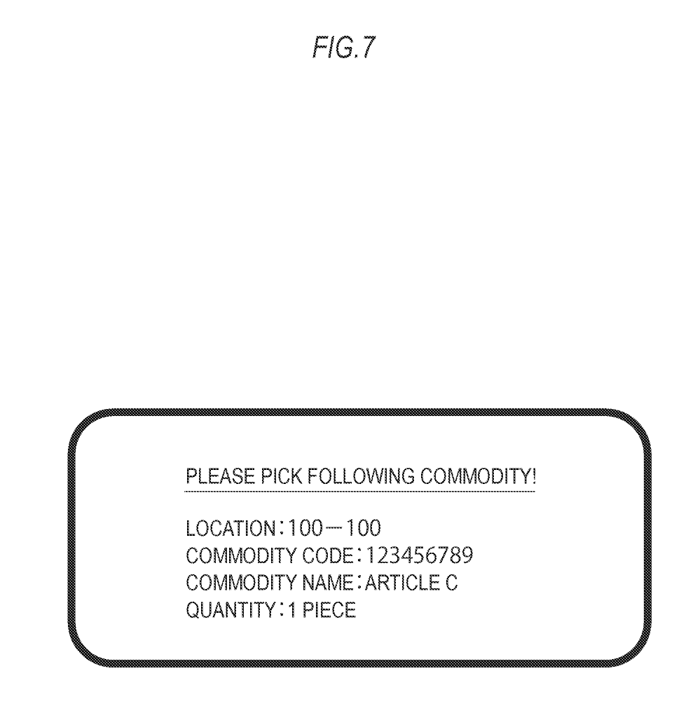

FIG. 7 illustrates an exemplary picking instruction screen displayed on the display 14 when the CPU 10 has received the picking instruction. The picking instruction screen in FIG. 7 includes display of a message that instructs the picking, the position (location) of the shelf where the picking target article is stored, the article code of the picking target article, an article name of the picking target article, and a quantity to be picked. The worker who wears the smart glasses 100 can visually perceive this screen with being superimposed on the actual scenery to know where, what, and how many is to be picked up by oneself.

The worker refers the information on the location displayed on the picking instruction screen as in FIG. 7 to move to the position of the shelf 500 indicated by this location. The worker looks the location marker 501 stuck on the shelf after arriving in front of the shelf 500 (for example, in accordance with a preliminarily determined rule such as looking it head on). The worker searches the picking target article about 1 to 1.5 m about ahead of the shelf corresponding to a layout of the shelf in the warehouse. In this embodiment, the worker is assumed to be positioned 1 m ahead of the shelf. However, the worker may be assumed to be positioned, for example, 1.5 m ahead of the shelf corresponding to an actual layout.

Thus, in CS602, the CPU 10 photographs the location marker 501 via the camera 110. At this time, the CPU 10 determines whether the location indicated by the location marker 501 matches the location included in the picking instruction transmitted in CS601 or not, and displays information indicating that the worker has arrived at an exact shelf on the display 14 when the locations match each other. For example, the CPU 10 displays a blue highlight display as being superimposed on the location marker 501 to notify the worker that he/she has arrived at the exact shelf. Conversely, when the location indicated by the location marker 501 does not match the location included in the picking instruction transmitted in CS601, the CPU 10 displays a red highlight display as being superimposed on the location marker 501 to notify the worker of inaccuracy of the shelf.

In CS603, the CPU 10 estimates the height of the worker based on an image of the location marker 501 photographed via the camera 110 in CS602 and the elevation/depression angle of the smart glasses 100 in the photographing. A process in CS603 will be described in detail. In this embodiment, the smart glasses 100 in the photographing turns up to form an elevation angle since the location marker 501 exists on the position higher than the height of the worker. However, when the location marker 501 exists on a position at a height less than the height of the worker, the smart glasses 100 in the photographing will turn down to form a depression angle.

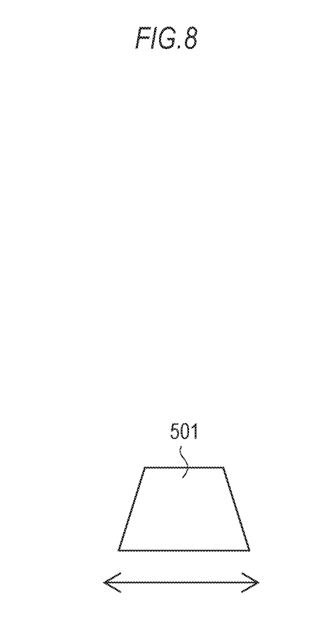

The location marker 501 stuck on the shelf 500 exists on the position higher than the height of the worker. Therefore, when the location marker 501 is looked from below, the location marker 501 has a trapezoidal shape as in FIG. 8, and the location marker 501 in the image photographed in CS602 also has a trapezoidal shape. The CPU 10 obtains a length (a pixel unit) of a bottom side of the location marker 501 in the image photographed in CS602.

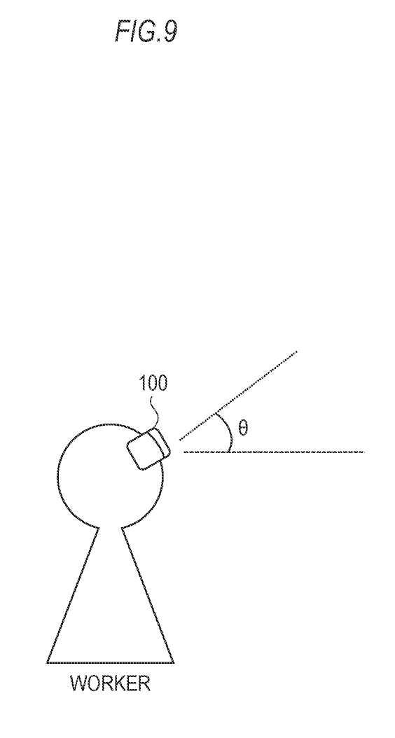

In the photographing of the location marker 501 in CS602, the CPU 10 obtains an elevation/depression angle θ of the smart glasses 100 in the photographing of the location marker 501, based on information output from a sensor such as an acceleration sensor, a gravity sensor, or a gyro sensor of the smart glasses 100. FIG. 9 is a diagram illustrating an exemplary situation of the worker who is wearing the smart glasses 100 in the photographing of the location marker 501.

If it is known, when the camera 110 has photographed its front with looking up at the elevation/depression angle θ, with how much length the bottom side of the location marker 501, which has a set size and has been stuck at a set height, has been photographed, it is possible to estimate the height of the worker. For example, the CPU 10 estimates the height of the worker from the length (pixel unit) of the bottom side of the location marker 501 in the image photographed in CS602 and the size of the location marker 501.

The following describes the configuration to estimate the height of the worker in more detail. There is a correlation relationship between the length of the bottom side of the location marker 501 in the image and the elevation/depression angle of the smart glasses 100 in the photographing, and the height of the worker. For example, for the location marker 501 stuck on the position higher than the height of the worker, when a certain person looks up the location marker 501, the elevation/depression angle is small compared with a case where a person whose height is lower than that person looks up. When persons whose heights are similar look up the location marker 501, the smaller the elevation/depression angle is, the smaller the length (pixel unit) of the bottom side of the location marker 501 is.

In this embodiment, in the information processing system, the configuration using the smart glasses 100 is described as an example, as the information processing device carried by the worker. However, in the information processing system, another smart device (for example, a smart phone and a tablet) may be used as the information processing device carried by the worker. In this case, the worker will carry the smart device and hold the carrying smart device at a position similar to that of the smart glasses 100 in the photographing. Therefore, the smart device can estimate the height of the worker similarly to the smart glasses 100. The other smart device (for example, the smart phone and the tablet) may also execute various processes using the smart glasses 100, which are described later, not limited to the process to estimate the height.

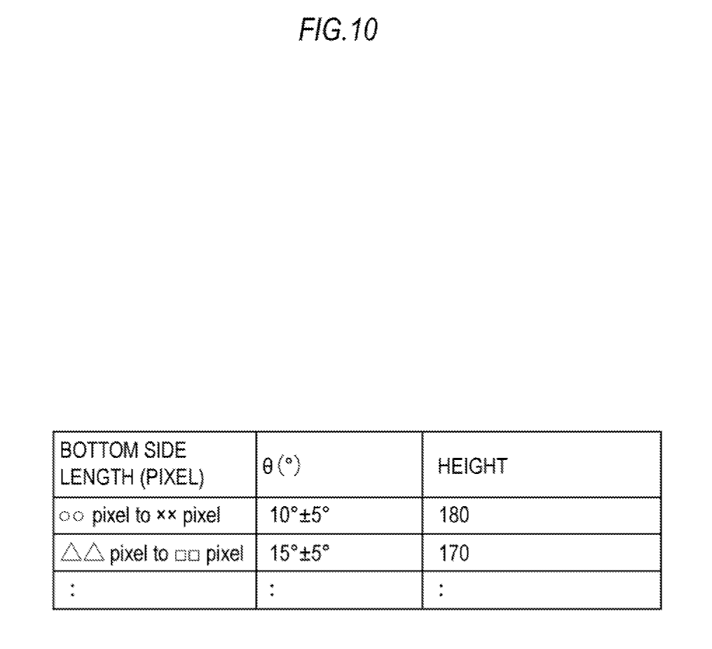

Then, this embodiment assumes that the CPU 10 makes the estimation as follows. This embodiment assumes that the memory 31 preliminarily stores correspondence information between the length of the bottom side of the location marker 501 in the image and the elevation/depression angle of the smart glasses 100 in the photographing, and the height of the worker. FIG. 10 is a diagram illustrating exemplary correspondence information between the length of the bottom side of the location marker 501 in the image and the elevation/depression angle of the smart glasses 100 in the photographing, and the height of the worker.

The CPU 10 may estimate the height of the worker, for example, as follows, based on information on height at which the location marker 501 has been stuck. That is, the CPU 10 can determine a difference in height between a vertex portion of the worker and the location marker 501 from a distance in a horizontal direction between the camera 110 and the location marker 501 (a distance in the horizontal direction between the camera 110 and the shelf on which the location marker 501 has been stuck, that is, the above-described distance of 1 to 1.5 m) and the elevation/depression angle θ. Accordingly, the CPU 10 can estimate the height of the worker by subtracting the determined difference in height between the vertex portion of the worker and the location marker 501 from the height of the location marker 501. The CPU 10 can know the height of the location marker 501 from the information on the height of the location marker 501 preliminarily stored in the memory 11.

When a subject is photographed without changing setting of the camera, the larger a distance between the subject and the camera is, the smaller the subject is captured, and the smaller the distance between the subject and the camera is, the larger the subject is captured. That is, there is a correlation between a size of the subject in the image and the distance between the subject and the camera. Therefore, when the size of the subject is already known, a direct distance between the camera and the subject can be estimated from the size of this subject in the image photographed with the camera. Then, the CPU 10 may estimate the height of the worker as follows. That is, the CPU 10 estimates a direct distance between the location marker 501 and the camera 110 from the size of the bottom side of the location marker 501 in the image obtained in CS602 and the information on the size of the location marker 501. The CPU 10 determines the difference in height between the vertex portion of the worker and the location marker 501 from the estimated direct distance between the location marker 501 and the camera 110 and the elevation/depression angle θ of the smart glasses 100 in the photographing of the location marker 501. Then, the CPU 10 may estimate the height of the worker by subtracting the determined difference in height between the vertex portion of the worker and the location marker 501 from the height of the location marker 501. With such a process, the CPU 10 can estimate the height of the worker even when the distance in the horizontal direction between the worker and the shelf is unknown.

The CPU 10 does not need to precisely identify the height of the worker. It is only necessary for the CPU 10 to obtain an approximate height of the article (for example, on which stage of the shelf the article has been placed) as the position information of the article, and therefore, it is only necessary to estimate the height of the worker with a sufficient accuracy.

This embodiment assumes that the information processing system estimates the height of the worker to obtain the position information in a height direction of the photographed article from the estimated height of the worker. However, for example, when the worker inputs and registers the height in the memory 31 before the work via an operating unit of the server device 130, or when height information has been preliminarily registered in master information that manages the worker registered in the memory 31, the information processing system may calculate the position information in the height direction of the article based on the preliminarily registered height of the worker without estimating the height of the worker.

Then, the CPU 10 executes the following process based on the obtained length of the bottom side of the location marker 501 in the image photographed in CS602, the elevation/depression angle θ of the smart glasses 100 in the photographing in CS602, and the correspondence information stored in the memory 31. That is, the CPU 10 obtains the height corresponding to the length of the bottom side of the location marker 501 in the image photographed in CS602 and the elevation/depression angle θ of the smart glasses 100 in the photographing in CS602 from the correspondence information stored in the memory 31. Then, the CPU 10 estimates the obtained height as the height of the worker. The CPU 10 can reduce a load in the calculation process by estimating the height of the worker with the above-described process, compared with a case to estimate with calculation.

The CPU 10 is assumed to use information indicating the correspondence between the length of the bottom side of the location marker and the elevation/depression angle θ, and the height of the worker as the correspondence information used for the estimation of the height of the worker. However, the CPU 10 may use, for example, information indicating a correspondence between a ratio of view angle of the bottom side of the location marker and the elevation/depression angle, and the height of the worker. Here, the ratio of view angle is a ratio of the number of pixels that indicates the size of the bottom side of the location marker 501 in the image to a view angle pixel (the number of pixels that indicates a size of a lateral width of the image).

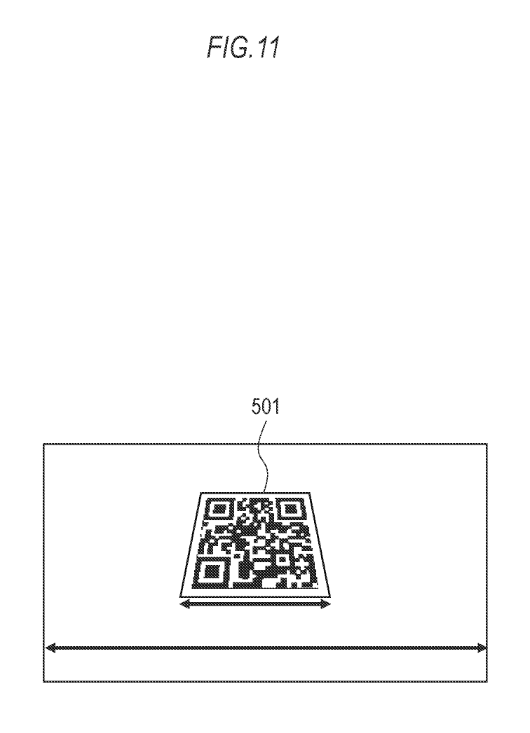

FIG. 11 is a diagram describing the ratio of view angle. An image in FIG. 11 is an exemplary image of the location marker 501 photographed with the camera 110. A lower double-headed arrow in the image in FIG. 11 indicates an end-to-end length (the number of pixels) in a lateral direction of the image photographed with the camera 110. An upper double-headed arrow in the image in FIG. 11 indicates the length (the number of pixels) of the bottom side of the location marker 501 in the image photographed with the camera 110. In the example in FIG. 11, the ratio of view angle of the bottom side of the location marker 501 is a ratio of the length of the upper double-headed arrow to the length of the lower double-headed arrow in the image in FIG. 11, and the ratio can be obtained, for example, by calculating (the length of the upper double-headed arrow) (the length of the lower double-headed arrow).

The correspondence information used for the estimation of the height of the worker is not necessary data in a table form. For example, when it is assumed that there is a linear relationship between the ratio of view angle and the elevation/depression angle for the workers whose heights are identical, the linear relationship between the ratio of view angle and the elevation/depression angle is expressed in a primary expression. Therefore, for example, it is assumed that an experiment and the like has been preliminarily performed and the primary expression showing the linear relationship between the ratio of view angle and the elevation/depression angle for each height of the worker has been determined. The memory 31 may store the primary expression showing the linear relationship between the ratio of view angle and the elevation/depression angle, which has been determined for each height of the worker, as the correspondence information used for the estimation of the height of the worker. The memory 31, for example, stores the primary expression showing the linear relationship between the ratio of view angle and the elevation/depression angle each for a case where the height of the worker is 170 cm and a case where the height of the worker is 180 cm, as the correspondence information used for the estimation of the height of the worker.

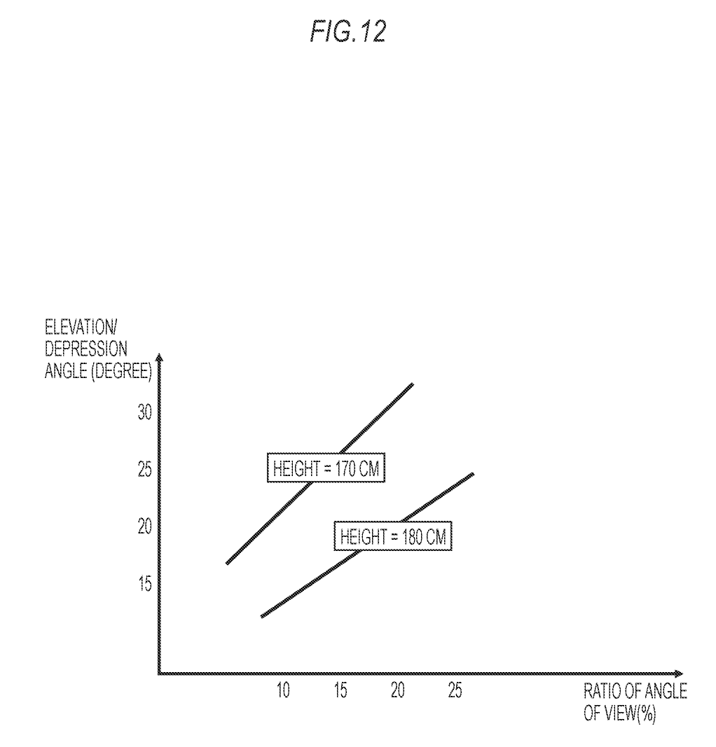

FIG. 12 is a diagram describing an exemplary estimating method of the height. A coordinate system in FIG. 12 is a coordinate system taking the ratio of view angle in a horizontal axis and the elevation/depression angle in a vertical axis. The example in FIG. 12 illustrates a graph showing the primary expression showing the linear relationship between the ratio of view angle and the elevation/depression angle when the height of the worker is 170 cm and a graph showing the primary expression showing the linear relationship between the ratio of view angle and the elevation/depression angle when the height of the worker is 180 cm. The CPU 10, for example, identifies a point on the coordinate system in FIG. 12 corresponding to the ratio of view angle obtained from the image photographed in CS602 and the elevation/depression angle θ of the smart glasses 100 in the photographing in CS602, in the warehouse work. Then, the CPU 10 may calculate a distance between the identified point on the coordinate system in FIG. 12 and the graph for each height to estimate a height corresponding to the graph whose calculated distance is minimum as the height of the worker.

It is preferable that the information processing system has registered the correspondence information used for the estimation of the height of the worker for each distance between the worker and the shelf to use different registered correspondence information corresponding to the distance between the worker and the shelf since there is a case where the distance between the worker and the shelf is different depending on the warehouse as the work place.

When the worker looks various places in the shelf 500 to search the article C, there is a case where various articles enter a photographing range of the camera 110. This embodiment assumes that the marker 502 stuck on the article A enters the photographing range of the camera 110 while the worker is searching the article C. In this case, the CPU 10 executes the following process in CS604.

In CS604, the CPU 10 photographs the marker 502 stuck on the article A via the camera 110 corresponding to change in a visual line of the worker. The CPU 10 identifies the article on which the marker 502 has been stuck as the article A based on the photographed marker 502. The CPU 10 executes the following process in CS605.

For example, when identical commodities exist on a plurality of places in an identical shelf or a plurality of commodities are contained in one corrugated cardboard, and only the commodities with a necessary quantity are picked from there, there is a case where not all the commodities are released even the commodities are the picking target articles. That is, even when the picking target article is photographed, this photographed article may remain in the shelf after the picking work. In such a case, the position information of this article may become useful information in the later warehouse work. Therefore, in this embodiment, the CPU 10 executes an obtaining process (the process in CS605) of the position information regardless of whether the photographed article is the picking target article or not. However, for example, when the warehouse stores only one piece for each identical type of article, the position information of the picking target article will not be utilized in the later work. In such a case, the CPU 10 may determine whether the article photographed in CS604 is different from the picking target article or not, execute the process in CS605 when determining that the article photographed in CS604 is an article different from the picking target article, and determine not to execute the process in CS605 when determining that the article photographed in CS604 is an article identical to the picking target article.

In CS605, the CPU 10 obtains the position information in the height direction of the article photographed in CS604 based on the height of the worker estimated in CS603. For example, the CPU 10 obtains the position information in the height direction of the article photographed in CS604 by executing a process as follows. That is, the CPU 10 obtains the elevation/depression angle θ of the smart glasses 100 in the photographing of the article A in CS604 based on information output from the sensor of the smart glasses 100. Then, the CPU 10 obtains the height of the article photographed in CS604 from the obtained elevation/depression angle θ and the height of the worker estimated in CS603 by calculating the height+1 m×tan(θ).

The CPU 10 may identify which of the upper stage, the middle stage, and the lower stage in the shelf stores the article photographed in CS604 to obtain any of the upper stage, the middle stage, and the lower stage, which has been identified, as the position information in the height direction of the article photographed in CS604. For example, the CPU 10 may identify which of near the upper stage, the middle stage, and the lower stage in the shelf stores the article photographed in CS604, based on to which of ranges set corresponding to near the upper stage, the middle stage, and the lower stage in the shelf 500 (for example, 1.6 to 2.2 m is the upper stage, 0.7 to 1.6 m is the middle stage, and 0 to 0.8 m is the lower stage) the height of the article obtained in CS604 belongs.

The CPU 10 also obtains the position information in the horizontal direction of the article photographed in CS604. For example, the CPU 10 obtains the position information in the horizontal direction of the article photographed in CS604 with the following process. That is, the CPU 10 obtains the azimuth angle of the smart glasses 100 in the photographing of the article A in CS604 based on the information output from the sensor of the smart glasses 100. Then, the CPU 10 obtains the position information in the horizontal direction of the article photographed in CS604 based on the obtained azimuth angle. For example, it is assumed that a difference between the azimuth angle of the smart glasses 100 in the photographing of the article A in CS604 and the azimuth angle when the worker, who has arrived in front of the shelf, first looks the location marker 501 (that is, the azimuth angle when the worker directly faces the shelf at right angle) is a to left from a front direction, and the distance between the shelf 500 and the worker is 1 m. In this case, the CPU 10 obtains the position information indicating that the article is positioned left by 1m×tan(a) from the center of the shelf 500 (the position on which the location marker 501 has been stuck in the horizontal direction) as the position information in the horizontal direction of the article photographed in CS604.

The worker will take a view right and left from a state opposite to the shelf when searching the article. Therefore, the CPU 10 may calculate an angle α in the horizontal direction, for example, as a value obtained by integrating an angular speed in the horizontal direction of the gyro sensor included in the smart glasses 100 or the like.

The CPU 10 may identify which of the right side, the left side, and near the center in the shelf stores the article photographed in CS604, from the azimuth angle of the smart glasses 100 in the photographing in CS604 to obtain any of the right side, the left side, and near the center, which has been identified, as the position information in the horizontal direction of the article photographed in CS604. For example, the CPU 10 may identify which of the right side, the left side, and near the center in the shelf stores the article photographed in CS604, based on to which of ranges set corresponding to the right side, the left side, and near the center in the shelf 500 the azimuth angle of the smart glasses 100 in the photographing in CS604 belongs.

In CS606, the CPU 10 transmits a registration instruction of the position information of the article photographed in CS604, which has been obtained in CS605, to the server device 130. The CPU 10 puts the article code of the article photographed in CS604 and the position information obtained in CS605 in the registration instruction to be transmitted.

In CS607, the CPU 30 stores and registers the position information included in the transmitted registration instruction, with being associated with the article code included in the transmitted registration instruction, in the memory 31 corresponding to the registration instruction transmitted in CS606.

With the above-described process, the information processing system can register the position information of the article photographed in CS604 in the memory 31 during the picking work by the worker. This enables the information processing system to, after this process, present the position information of the article to the worker who picks the article whose position information has been registered.

(Position Information Presentation Process of Article)

Subsequently, a presentation process of the position information of the article will be described. It is assumed that, after the process in FIG. 6, a certain worker comes to pick the article A. It is assumed that this worker is different from the worker who has picked the article C in FIG. 6, but may be the identical worker. This worker is wearing the smart glasses 100. This embodiment assumes that these smart glasses 100 are different from those used in FIG. 6, but may be the identical ones.

The CPU 30 transmits the picking instruction of the article A as the picking target article to the smart glasses 100. The CPU 30 puts the position information of the shelf 500 in which the article A as the picking target has been stored, the article code of the article A, information on the name, information on the number of the articles A to be picked, and the like in the picking instruction to be transmitted. Since the position information of the article A has been registered in the memory 31, the CPU 30 puts it in the picking instruction to be transmitted.

The CPU 10, after receiving the picking instruction, displays the picking instruction screen that instructs the picking as in FIG. 7, with being superimposed on the actual scene, on the display 14, for example, based on the information included in the received picking instruction.

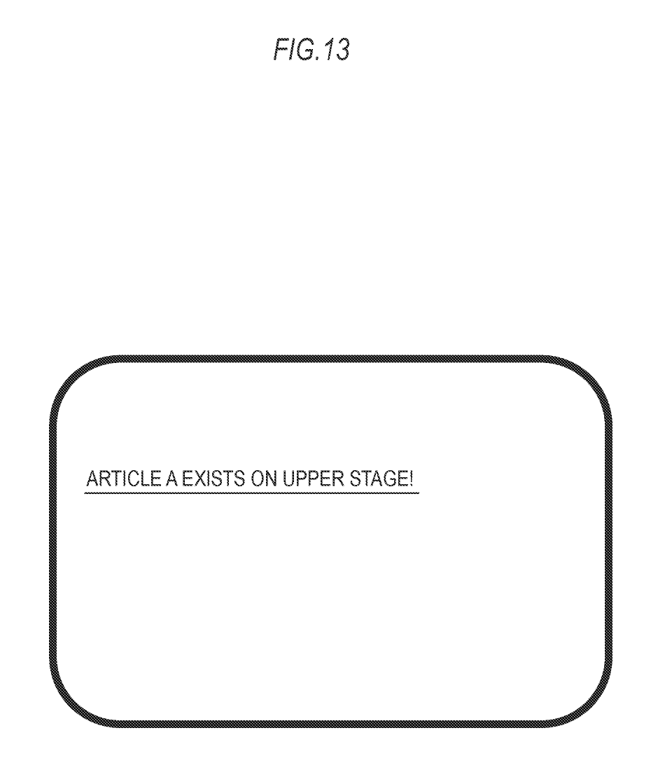

The CPU 10 obtains the height of the article A based on the position information of the article A included in the received picking instruction. It is assumed that the memory 11 has preliminarily stored information on the height of the lower stage, the height of the middle stage, and the height of the upper stage in the shelf 500. The CPU 10 determines which stage stores the article A, based on the heights of the respective stages in the shelf 500 stored in the memory 11 and the obtained height of the article A. This embodiment assumes that the CPU 10 has determined that the article A exists on the upper stage in the shelf 500. Then, the CPU 10 displays a position information presentation screen that presents the position information of the article A on the display 14. FIG. 13 is a diagram illustrating an exemplary position information presentation screen. The position information presentation screen includes, for example, a character string indicating the position information of the picking target article. In the example in FIG. 13, the position information presentation screen includes a message indicating that the article A exists on the upper stage in the shelf 500.

In a case of a configuration where information indicating which stage stores the article as the position information in the height direction of the article is registered in CS605, the CPU 10 may read this information from the memory to present the information indicating which stage stores the article, on the position information presentation screen.

It is assumed that the CPU 10 puts the character string indicating which stage in the shelf 500 stores the article A in the position information presentation screen, but may put a character string indicating a coordinate value of the article A. The CPU 10 may output the information indicated in the position information presentation screen as the audio via the microphone 120 instead of displaying the position information presentation screen on the display 14.

(Detail of Process of Smart Glasses)

FIG. 14 is a flowchart illustrating an exemplary process of the smart glasses 100. The process of the smart glasses 100 in the obtaining/registering process of the position information of the article and a position information presentation process of the article will be described in detail using FIG. 14.

In S1201, the CPU 10 receives the picking instruction from the server device 130.

In S1202, the CPU 10 determines whether the position information of the picking target article is included in the picking instruction received in S1201 or not. The CPU 10 proceeds to the process in S1203 when determining that the position information of the picking target article is included in the picking instruction received in S1201. The CPU 10 proceeds to the process in S1204 when determining that the position information of the picking target article is not included in the picking instruction received in S1201.

In S1203, the CPU 10 displays the position information presentation screen indicating the position information of the picking target article included in the picking instruction received in S1201 on the display 14.

In S1204, the CPU 10 photographs the location marker 501 via the camera 110.

In S1205, the CPU 10 obtains the length (pixel unit) of the bottom side of the location marker 501 in the image from the image of the location marker 501 photographed in S1204.

In S1206, the CPU 10 obtains the elevation/depression angle θ of the smart glasses 100 in the photographing in S1204 based on the information output from the sensor of the smart glasses 100 in the photographing in S1204.

In S1207, the CPU 10 estimates the height of the worker based on the length of the bottom side of the location marker 501 obtained in S1205 and the elevation/depression angle θ obtained in S1206. The CPU 10 obtains the height corresponding to the length of the bottom side of the location marker 501 obtained in S1205 and the elevation/depression angle θ obtained in S1206 from the correspondence information stored in the memory 31 between the length of the bottom side of the location marker 501 and the elevation/depression angle θ, and the height of the worker. Then, the CPU 10 estimates the obtained height as the height of the worker.

In S1208, the CPU 10 photographs the article via the camera 110. The CPU 10, for example, can photograph the marker stuck on the article placed in the warehouse and recognize the photographed marker to know that the article has been photographed.

In S1209, the CPU 10 obtains the elevation/depression angle θ of the smart glasses 100 in the photographing in S1208 based on the information output from the sensor of the smart glasses 100 in the photographing in S1208.

In S1210, the CPU 10 obtains the position information in the height direction of the article photographed in S1208 based on the height of the worker estimated in S1207 and the elevation/depression angle θ obtained in S1209. The CPU 10 obtains the position information in the height direction of the article photographed in S1208, for example, using the formula: the height+1 m×tan(0).

In S1211, the CPU 10 obtains the azimuth angle θ of the smart glasses 100 in the photographing in S1208 to obtain the position information in the horizontal direction of the article photographed in S1208 based on the obtained azimuth angle.

In S1212, the CPU 10 transmits the registration instruction of the position information of the article obtained in S1210 and S1211 to the server device 130. The CPU 10 puts the position information in the height direction obtained in S1210, the position information in the horizontal direction obtained in S1211, and the article code of the article photographed in S1208 in the registration instruction to be transmitted.

In S1213, the CPU 10 determines whether the CPU 10 has accepted a notification indicating the end of the picking work or not based on the operation by the worker via an operating unit of the smart glasses 100 or the microphone 120. When the worker has input the audio indicating the end of the picking work, for example, via the microphone 120, the CPU 10 determines that the CPU 10 has accepted the notification indicating the end of the picking work to end the process in FIG. 14. When the CPU 10 determines that the CPU 10 has not accepted the notification indicating the end of the picking work from the worker, the CPU 10 proceeds to the process in S1208.

(Process in Movement of Article)

In the warehouse or the like, for example, there is a case where an existing article is moved because of ensuring a placed position or the like in the warehousing of a new article.

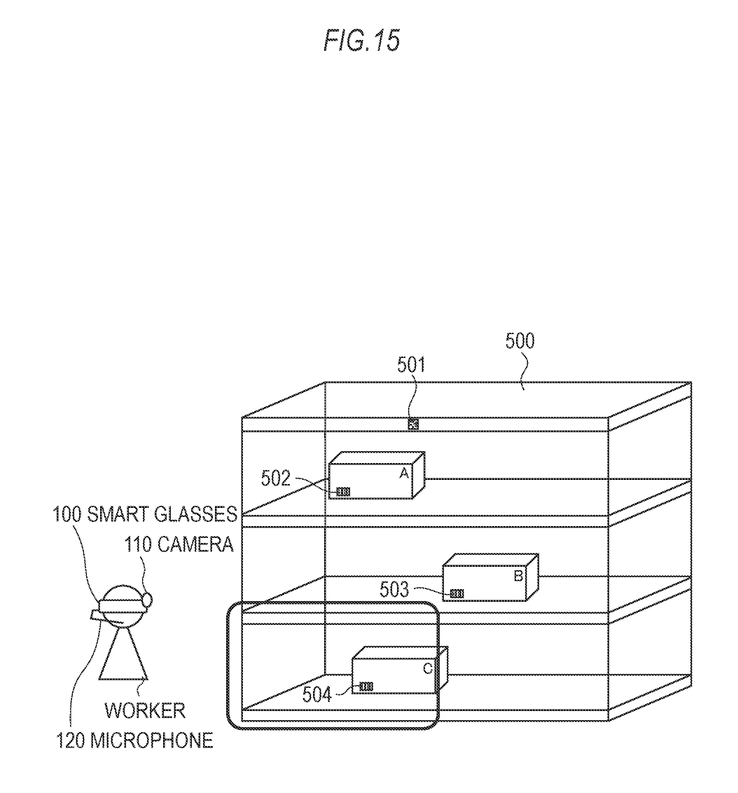

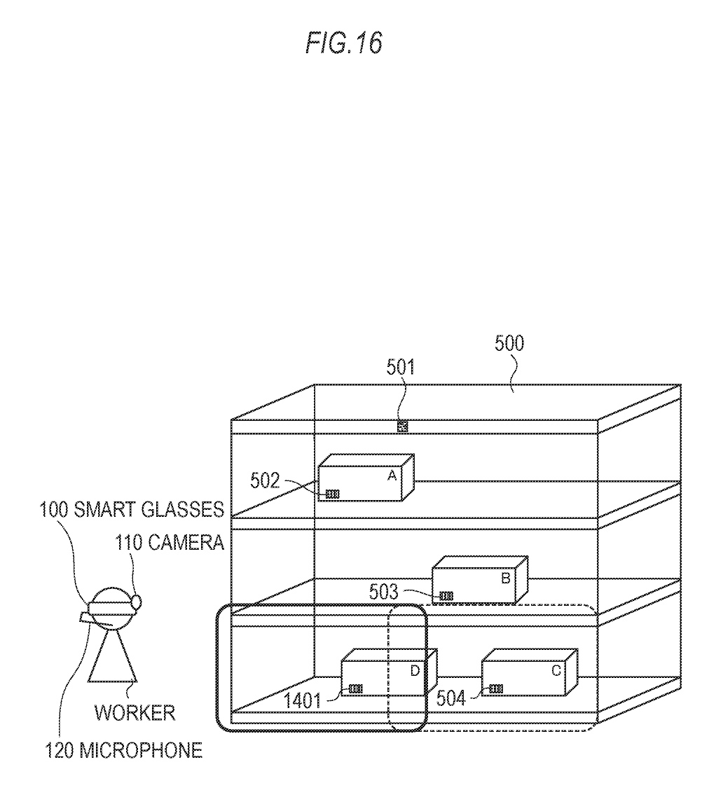

FIG. 15 and FIG. 16 are diagrams describing an exemplary movement of the article. A situation illustrated in FIG. 16 indicates a situation where an article D has been warehoused and the article C has been moved after a situation illustrated in FIG. 15.

It is assumed that the worker who is performing the picking work in the situation in FIG. 15 has photographed the article C and the information processing system has registered the position information of the article C. It is assumed that, after the situation in FIG. 15, the article D has been warehoused and the article C has been moved before the situation in FIG. 16. It is assumed that, then, the worker who is performing the picking work in the situation in FIG. 16 has photographed the article C.

In this case, the CPU 30 executes the following process, for example, in CS607. That is, the CPU 30, assuming that the position information corresponding to the article code included in the registration instruction transmitted in CS606 has been already registered in the memory 31, updates the registered position information with the position information included in the transmitted registration instruction. The CPU 30 can change the position information of the article registered in the memory 31 to newer information. This enables the information processing system to present the newer position information of the picking target article to the worker.

(Effect)

As described above, in this embodiment, the information processing system obtains the position information of the article photographed via the camera 110 with the smart glasses 100 worn by the worker who is performing the picking work to register the obtained position information in the memory 31. That is, in the picking of the worker, the information processing system can obtain and register the position information of the article for a subsequent worker.

This enables the information processing system to present the position information of the article to the worker who picks this article later, thus supporting the worker. That is, with the process in this embodiment, the information processing system provides the support to register the position information of the article unintentionally photographed during the picking work by the worker who performs the picking to present the registered position information to another worker who picks this article. That is, the information processing system can present the position information of the article to facilitate the search of this article, thus ensuring an efficiency in the search of this article. The information processing system can provide such support to the other worker to improve an efficiency in the picking work.

The information processing system can present the position information of the article registered with the process in this embodiment to a worker who performs the warehouse work other than the picking work to provide the support of the warehouse work. For example, the information processing system can provide the support to present the position information of each article to the worker who is performing the organization work of the article in the warehouse for inventory readjustment to enable the worker to know the position of each article.

In this embodiment, the information processing system obtains and registers the position information of the article photographed with the camera 110 in the memory 31, when the worker who is carrying the smart glasses 100 performs the picking work. However, the information processing system may obtain and register the position information of the article photographed with the camera 110 in the memory 31, when the worker who is carrying the smart glasses 100 performs the warehouse work other than the picking work. The information processing system may obtain and register the position information of the article photographed with the camera 110 in the memory 31, for example, when the worker, who is carrying the smart glasses 100 and performing an inventory confirmation work in the warehouse, performs the work. That is, in this case, the information processing system will obtain and register the position information of the article included in the image unintentionally photographed with the camera 110 in the memory 31, when the worker looks the placed portion such as the shelf for inventory confirmation.

In this embodiment, not the CPU 30 of the server device 130 but the CPU 10 of the smart glasses 100 executes the obtaining process of the position information of the article. This enables the CPU 10 to reduce the load of the process of the CPU 30 and reduce an amount of the data exchanged between the server device 130 and the smart glasses 100 to save a communication band between the server device 130 and the smart glasses 100.

Corresponding to the required specification of the system, the server device 130 may execute the process to obtain the position information of the article.

(Modification)

The following describes a modification of this embodiment.

In this embodiment, when the position information of the picking target article has been registered, the information processing system identifies the position of the picking target article based on the registered position information to present the identified position to the worker. However, the information processing system, for example, may present the position information indicating a relative position of the picking target article with respect to the position currently looked by the worker based on the registered position information.

For example, the CPU 10 executes the following process after estimating the height of the worker, in the process in S1207 without executing the process of S1202 to S1203. That is, the CPU 10 obtains the current elevation/depression angle θ of the smart glasses 100 based on the information output from the sensor included in the smart glasses 100. Then, the CPU 10 obtains the height of the position currently looked by the worker based on the height of the worker estimated in S1207 and the current elevation/depression angle θ of the smart glasses 100, for example, using the formula: the height+1 m×tan(θ). The CPU 10 obtains the current azimuth angle of the smart glasses 100 based on the information output from the sensor included in the smart glasses 100 to obtain the position information in the horizontal direction of the position currently looked by the worker based on the obtained azimuth angle.

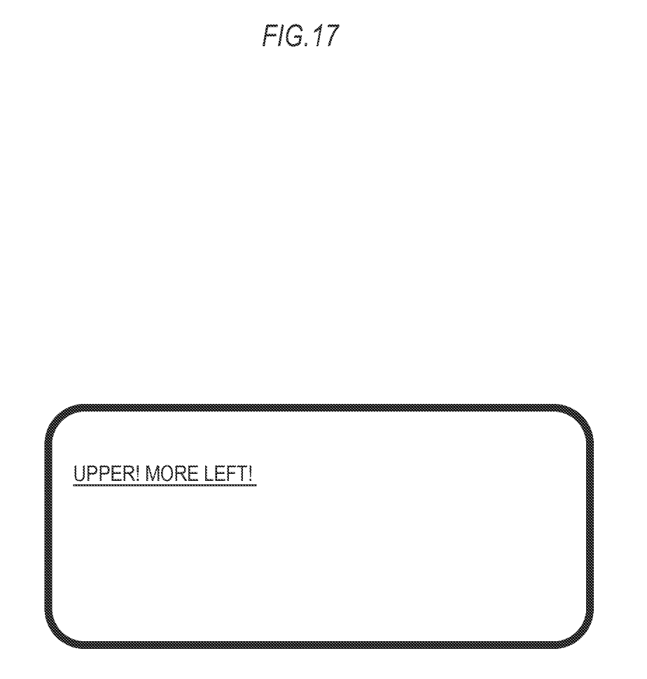

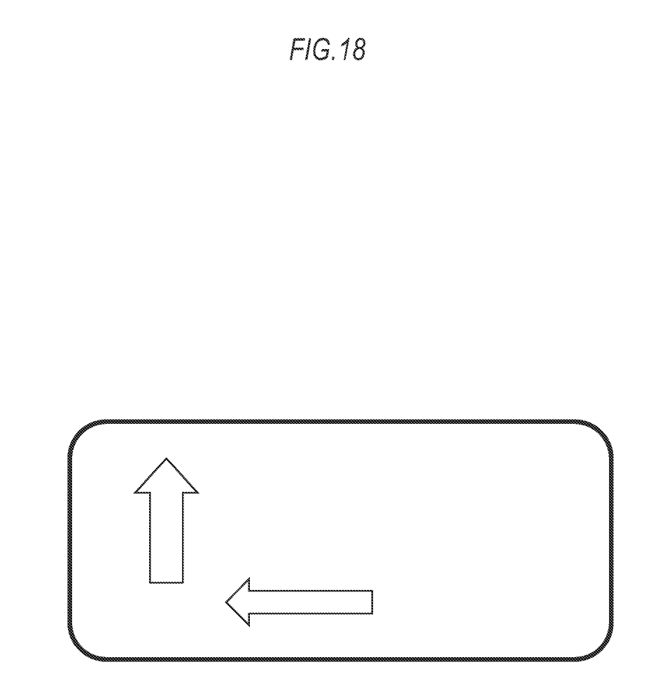

Then, the CPU 10 identifies in which direction from the position currently looked by the worker the picking target article exists, based on the position information of the picking target article included in the picking instruction received in S1201 and the position information of the obtained position currently looked by the worker. For example, the CPU 10, when identifying that the picking target article exists upper left from the position currently looked by the worker, displays the position information presentation screen as in FIG. 17 on the display 14. The position information presentation screen in FIG. 17 includes a character string indicating that the picking target article exists upper and more left from the position currently looked by the worker. The CPU 10 may display the position information presentation screen including an arrow indicating the relative position of the picking target article with respect to the position currently looked by the worker as in FIG. 18 on the display 14.

In this embodiment, the information processing system updates the registered position information with the new obtained position information even when the position information of the article whose position information has been obtained has already registered.

However, the information processing system may update the position information of the article only when the position information of the article whose position information has been obtained has already registered and the new obtained position information is different from the registered position information. This enables the information processing system to reduce the load on an unnecessary update process.

The information processing system may update the position information of the article only when the position information of the article whose position information has been obtained has already registered and a set period has passed from a registered time.

In this embodiment, the information processing system provides an effect as follows by updating the registered position information with the new obtained position information even when the position information of the article whose position information has been obtained has already registered. That is, the information processing system provides the effect such that, when a certain article has been moved before the worker picks this article, if another worker photographs the article after the movement, the position information of this article can be registered to present the position information of this article to the worker. However, before the worker picks this article, the other worker does not necessarily photograph this article after the movement. In such a case, the information processing system may execute a process as follows.

The CPU 10 puts information on a time when the article has been photographed in CS604 (S1208) in the registration instruction to be transmitted, when transmitting the registration instruction of the position information of the article to the server device 130 in CS606 (S1212). Then, the CPU 30 registers the position information and the time information included in the transmitted registration instruction with being associated with the article code included in the registration instruction, in the memory 31 in CS607.

Then, when the worker who is wearing the smart glasses 100 comes to pick this article, the information processing system executes the following process. The CPU 30 transmits the picking instruction of the picking target article to the smart glasses 100. The CPU 30 puts the position information of the shelf in which the article as the picking target has been stored, the article code of the article, the information on the name, the information on the number of the articles to be picked, and the like in the picking instruction to be transmitted. Since the position information of this article and the time information have been registered in the memory 31, the CPU 30 puts this position information and the time information of the photographing in the picking instruction to be transmitted. The CPU 10, after receiving the picking instruction, displays the picking instruction screen that instructs the picking as in FIG. 7, with being superimposed on the actual scene, on the display 14, for example, based on the information included in the received picking instruction.

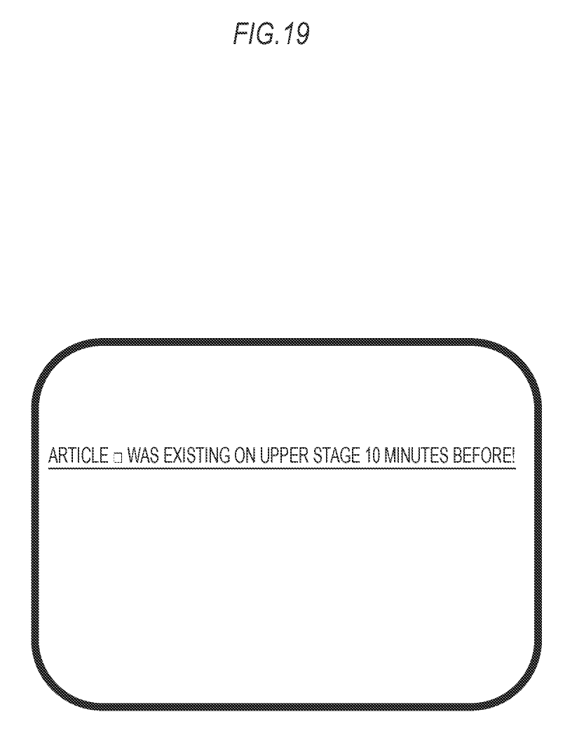

The CPU 10 identifies the position of the picking target article based on the position information included in the received picking instruction. The CPU 10 identifies how long ago this article was existing on the identified position from the current time, based on the time information included in the received picking instruction. Then, the CPU 10 displays the position information presentation screen indicating when this article was existing on the identified position on the display 14. The CPU 10 displays, for example, the position information presentation screen illustrated in FIG. 19 on the display 14. In the example in FIG. 19, the position information presentation screen includes a character string indicating that the article was existing on the upper stage in the shelf 10 minutes before.

The worker who has checked the screen in FIG. 19 searches the upper stage in the shelf. When the worker can find the picking target article, the worker picks this article. The worker searches the upper stage in the shelf, and when the worker cannot find the picking target article, the worker can know that this article was existing on the upper stage in the shelf 10 minutes before. In this case, the worker will search a range where the article may be moved within 10 minutes from the upper stage in the shelf. That is, the information processing system can present the information of the time when the article was existing on this position other than the position information of the article to the worker to present a suggestion of the range where this article can be moved to the worker when this article does not exist on this position.

CPU 10 is configured to put the information indicating how long ago the article was existing on this position from the current time in the position information presentation screen, but may put information indicating at what time the article was existing on this position.

When the time information corresponding to the position information of the picking target article registered in the memory 31 is earlier than the current time by a set threshold or more, the CPU 10 need not present this position information as it is old and unreliable information.

In this embodiment, the information processing system estimates the height of the worker to obtain the position information in the height direction of the article based on the estimated height of the worker. The information processing system also obtains the position information in the horizontal direction of the article.

However, for example, when the position markers indicating the positions have been stuck on respective places of the shelf in which the article has been placed, the information processing system may obtain the position information of the article as follows.

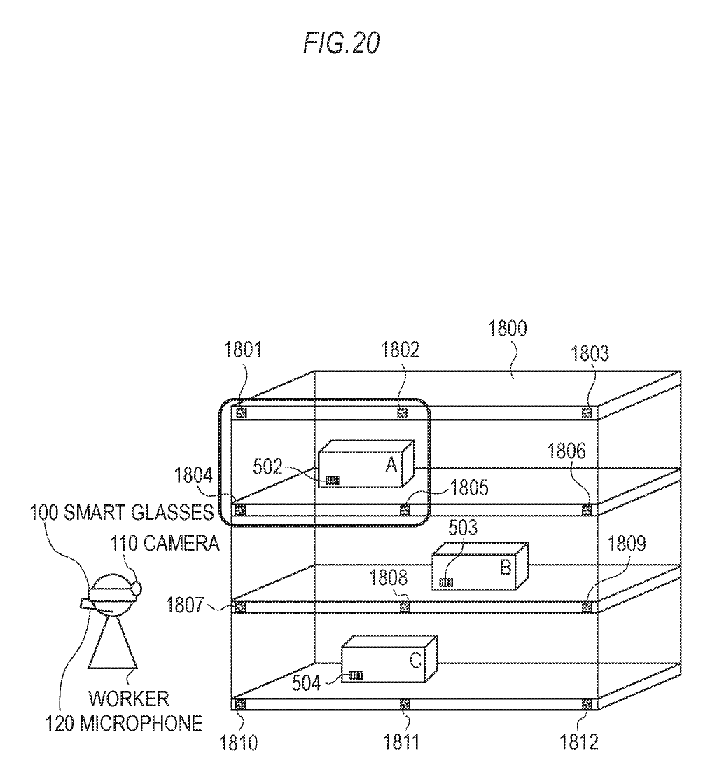

FIG. 20 is a diagram illustrating an exemplary situation where the worker is picking the article C placed in a shelf 1800 on which the position markers have been stuck. Position markers 1801 to 1812 have been stuck on the shelf 1800. Each of the position markers 1801 to 1812, which is a marker such as the two-dimensional code, the barcode, and the color code, is a marker indicating a position in the shelf 1800. For example, the position marker 1805 is a marker indicating a position at the center of the upper stage in the shelf 1800. The CPU 10 can photograph the position marker via the camera 110 to recognize the photographed position marker, thus obtaining information indicated by the position marker.

A frame in FIG. 20 indicates a range visually perceived by the worker. That is, the camera 110 photographs a range of this frame. In this case, the CPU 10 recognizes the position markers 1801, 1802, 1804, and 1805 together with the marker 502 stuck on the article A. Then, for example, as long as the CPU 10 defines and registers a range enclosed by the position markers 1801-1802-1804-1805 as a location 1, a range enclosed by the position markers 1802-1805-1806-1803 as a location 2, . . . to store them in the memory 31, the CPU 10 identifies that the article A exists in the location 1 (the position enclosed by the position markers 1801, 1802, 1804, and 1805). That is, the CPU 10 obtains information in a range from a left portion to the center of the upper stage in the shelf 1800 as the position information of the article A. Then, the CPU 10 transmits the registration instruction of the obtained position information of the article A to the server device 130.

With the above-described process, the CPU 10 can obtain the position information of the article without performing the process to estimate the height of the worker, thus ensuring reduction in the load of the process compared with the case to estimate the height of the worker.

The information processing system may obtain the position information of the article as follows when the article has been placed in the shelf on which the position marker has been stuck.

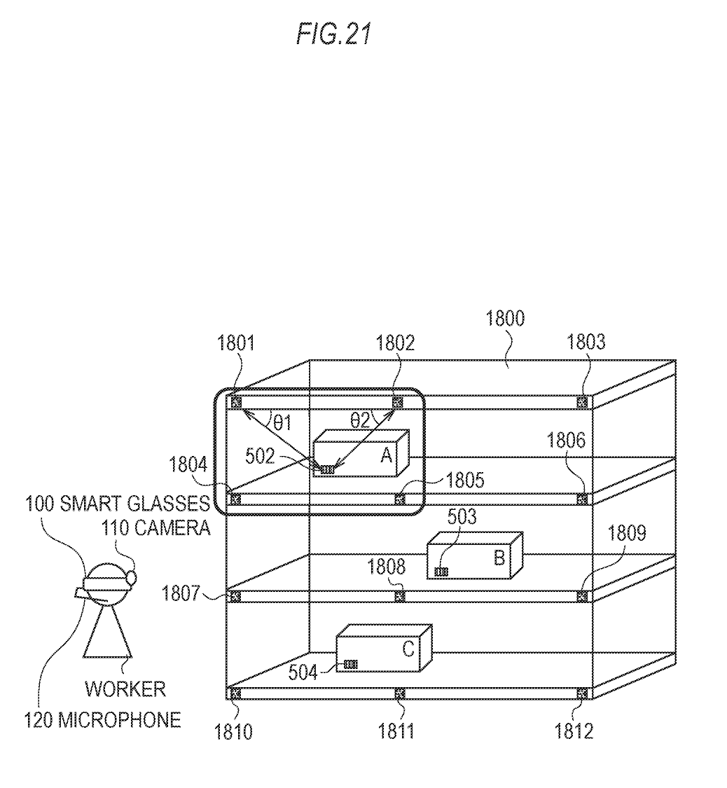

FIG. 21 is a diagram illustrating a situation similar to that in FIG. 20. A frame in FIG. 21 indicates a range photographed with the camera 110 similarly to the frame in FIG. 20. The CPU 10 obtains an image of a range of the frame in FIG. 21 via the camera 110. Then, the CPU 10 identifies in which direction the article A (the marker 502) is positioned with respect to the position markers 1801 and 1802. A triangle formed of the position markers 1801 and 1802 and the marker 502 is assumed. The CPU 10 identifies an angle of the position marker 1801 as 01 and an angle of the position marker 1802 as 02. That is, the CPU 10 identifies that the marker 502 is positioned in a direction expressed by the angle θ1 from the position marker 1801 and a direction expressed by the angle θ2 from the position marker 1802. Then, the CPU 10 identifies the position of the article A using triangulation, for example, based on the position indicated by the position markers 1801 and 1802 and the angles θ1 and 02 to obtain information indicating the identified position as the position information. For example, the CPU 10 may define and register such as the range enclosed by the position markers 1801-1802-1804-1805 as the location 1, the range enclosed by the position markers 1802-1805-1806-1803 as the location 2, . . . to obtain information indicating that the article A exists in the location 1 as the position information based on respective coordinates of the other position markers 1802 to 1812 when the position of the position marker 1801 is defined as a reference coordinate in the shelf and the identified position coordinate of the marker 502.

With the above-described process, the information processing system can obtain and register the position information of the article with higher accuracy. In this aspect, the information processing system eliminates the need to take all the four position markers stuck on the shelf in a visual field of the image of the camera and can obtain the position information, for example, insofar as the two position markers 1801 and 1802 stuck on the shelf and the marker 502 attached to the article can be taken in the visual field of the image of the camera.

In this embodiment, the information processing system obtains and registers the position information in the height direction of the article and the position information in the horizontal direction. However, the information processing system may obtain and register any of the position information in the height direction of the article and the position information in the horizontal direction of the article. For example, when it is enough that the worker can know which stage in the shelf stores the picking target article, the information processing system obtains and registers the position information in the height direction of the article. Then, the information processing system presents the position information in the height direction of the picking target article to the worker.

In this embodiment, the smart glasses 100 estimate the height of the worker. However, the server device 130 may estimate the height of the worker. In this case, the CPU 30 obtains the elevation/depression angle θ of the smart glasses 100 in the photographing of the location marker 501 and the length of the bottom side of the location marker 501 in the photographed image from the smart glasses 100 to estimate the height of the worker in a method similar to the method described in CS603. Then, the CPU 30 transmits information on the estimated height to the smart glasses 100. The server device 130 may further obtain and register the position information of the article photographed with the camera 110 in the memory 31, based on the estimated height of the worker. In this case, after the article is photographed with the camera 110, the CPU 10 transmits information on the elevation/depression angle and the azimuth angle of the smart glasses in the photographing to the server device 130. Then, the CPU 30 obtains and registers the position information of the photographed article in the memory 31, based on the transmitted information on the elevation/depression angle and the azimuth angle of the smart glasses in the photographing and the estimated height of the worker.

In this embodiment, the CPU 10 displays the position information of the picking target article with putting it in the presentation screen as in FIG. 13, on the display 14. However, the CPU 10 may present the position information of the picking target article to the worker by displaying the position information on the display 14 with putting it in the picking instruction screen as in FIG. 7.

In this embodiment, the information processing system registers the position information of the article in the memory 31. However, the information processing system may register the position information of the article, for example, in an external storage device such as an external hard disk and a storage server.

### Other Embodiment

As described above, the preferred embodiment of the present invention has been described in detail. However, the present invention is not limited to such a specific embodiment. For example, a part of or all of the function composition of the above-described information processing system may be implemented in the smart glasses 100 or the server device 130 as hardware.

The preferred embodiment of the present invention has been described above in detail. However, the present invention is not limited to such a specific embodiment. Various changes and modifications can be made without departing from the scope of the present invention as defined in the appended claims.

1. A system, comprising:
an obtainer configured to obtain position information of an article photographed with an imaging device for a first warehouse work activity as position information used for a second warehouse work activity performed after the first warehouse work activity; and
a register configured to register the position information obtained by the obtainer and identification information of the article in a storage unit, the position information being associated with the identification information of the article.

2. The system according to claim 1, wherein
the obtainer is configured to obtain information on a position in a height direction of the article as the position information based on a height of a worker for the first warehouse work activity.

3. The system according to claim 2, further comprising
an estimator configured to estimate the height of the worker for the first warehouse work activity, wherein
the obtainer is configured to obtain the information on the position in the height direction of the article as the position information based on the height of the worker for the first warehouse work activity, and the height is estimated by the estimator.

4. The system according to claim 3, wherein
the estimator is configured to estimate the height of the worker for the first warehouse work activity based on an image of a set marker photographed with the imaging device and an elevation/depression angle of the imaging device photographing the marker.

5. The system according to claim 1, wherein
the obtainer is configured to obtain information on a position in a horizontal direction of the article as the position information based on information output from a sensor of an information processing device carried by a worker for the first warehouse work activity.

6. The system according to claim 1, wherein
the obtainer is configured to obtain the position information based on a position indicated by a position marker located on a portion of the article.

7. The system according to claim 6, wherein
the obtainer is configured to obtain the position information based on the position indicated by the position marker photographed together with the article via an imaging device carried by a worker for the first warehouse work activity.

8. The system according to claim 7, wherein
the obtainer is configured to obtain the position information based on respective positions indicated by a plurality of position markers photographed together with the article and each direction of view of the article relative to the respective position markers.

9. The system according to claim 1, wherein
the register is configured to register the position information obtained by the obtainer, the identification information of the article, and information on a time when the position information was obtained by the obtainer in the storage unit, and the position information is associated with the identification information of the article and the information on the time.

10. The system according to claim 1, further comprising
a presenter configured to present the position information to a worker for the second warehouse work activity, the position information being associated with the identification information of the article and registered in the storage unit by the register.

11. The system according to claim 10, wherein
the presenter is configured to display a screen on a display unit to present the position information to the worker for the second warehouse work activity, the screen indicates the position information, and the position information is associated with the identification information of the article and registered in the storage unit by the register.

12. The system according to claim 10, wherein
the presenter is configured to display a screen on a display unit to present the position information to the worker for the second warehouse work activity, the screen indicates a relative position of a position indicated by the position information with respect to a position currently viewed by the worker for the second warehouse work activity, and the position indicated by the position information is associated with the identification information of the article and registered in the storage unit by the register.

13. The system according to claim 10, wherein
the presenter is configured to present the position information and time information to the worker for the second warehouse work activity, the position information is associated with the identification information of the article and registered in the storage unit by the register, and the time information is associated with the identification information of the article and registered in the storage unit.

14. The system according to claim 10, wherein
the presenter is configured not to present the position information registered in the storage unit by the register to the worker for the second warehouse work activity when a time indicated in time information is earlier than a current time by a set threshold or more, and the time information is associated with the article and registered in the storage unit by the register.

15. An information processing device, comprising:
an obtainer configured to obtain position information of an article photographed with an imaging device for a first warehouse work activity as position information used for a second warehouse work activity performed after the first warehouse work activity; and
a register configured to register the position information obtained by the obtainer and identification information of the article in a storage unit, the position information being associated with the identification information of the article.

16. The information processing device according to claim 15, wherein the obtainer comprises a pair of smart glasses.

17. An information processing method executed by a system, the information processing method comprising:
an obtaining step of obtaining position information of an article photographed with an imaging device for a first warehouse work activity as position information used for a second warehouse work activity performed after the first warehouse work activity; and
a registering step of registering the position information obtained in the obtaining step and identification information of the article in a storage unit, the position information being associated with the identification information of the article.

18. An information processing method executed by an information processing device, the information processing method comprising:
an obtaining step of obtaining position information of an article photographed with an imaging device for a first warehouse work activity as position information used for a second warehouse work activity performed after the first warehouse work activity; and
a registering step of registering the position information obtained in the obtaining step and identification information of the article in a storage unit, the position information being associated with the identification information of the article.

19. (canceled)

20. A computer readable recording medium that records a program to cause a computer to execute:
an obtaining step of obtaining position information of an article photographed with an imaging device for a first warehouse work activity as position information used for a second warehouse work activity performed after the first warehouse work activity; and
a registering step of registering the position information obtained in the obtaining step and identification information of the article in a storage unit, the position information being associated with the identification information of the article.
